(19) United States
(12) Patent Application Publication
(10) Pub. No.: US 2026/0330716 A1
(43) Pub. Date: Oct. 22, 2026

(54) VEHICLE PASSENGER DISPLAY MODIFICATION

(71) Applicant: Intel Corporation, Santa Clara, CA (US)

(72) Inventors: Cornelius Buerkle, Karlsruhe (DE); Ping Guo, Beijing (CN); Mee Sim Lai, Penang (MY); Kuan Heng Lee, Pulau Pinang (MY); Meng Siong Lee, Penang (MY); Fabian Oboril, Karlsruhe (DE); Frederik Pasch, Karlsruhe (DE); Say Chuan Tan, Penang (MY); Wei Seng Yeap, Penang (MY); Chien Chern Yew, Penang (MY)

(21) Appl. No.: 19/106,803

(22) PCT Filed: Sep. 30, 2022
(86) PCT No.: PCT/CN2022/123563

§ 371 Date: Feb. 26, 2025

(51) Int. Cl. G06T 11/60; B60J 3/04; B60R 1/27; B61D 49/00; B61L 23/04; G06F 3/01; G06T 7/20; G06V 10/25; G06V 10/764; G06V 20/58

(52) U.S. Cl. CPC G06T 11/60; B60J 3/04; B60R 1/27; B61D 49/00; B61L 23/041; G06F 3/012; G06T 7/20; G06V 10/25; G06V 10/764; G06V 20/58; B60R 2300/20; B60R 2300/307; B60R 2300/8093; G06T 2207/30196; G06T 2207/30261; G06T 2207/30268

(57) ABSTRACT

An apparatus, including: an interface configured to receive image data in real-time of a surroundings of a vehicle; processing circuitry configured to: identify a point of interest within the received image data; generate modified image data based on the received image data and the identified point of interest; and transmit the modified image data to be displayed to a vehicle passenger.

### TECHNICAL FIELD

Aspects described herein generally relate to a passenger vehicle visual augmentation system, and more particularly, to a passenger vehicle visual augmentation system for enhancing a passenger experience.

### BACKGROUND

Vehicle accidents are common. In Germany in 2020, there were 430 accidents injuring more than 500 people. And there were additional collisions with animals that went unreported. Unfortunately, even with the most advanced sensor technology, these events cannot be eliminated. Vehicles, such as trains, travelling at speeds above 150 km/h have stopping distances of several hundred meters up to few kilometers, which is out of sensor range.

Collisions are traumatic events for eyewitnesses. While today this is typically a single train driver, in future automated trains the number of eyewitnesses could be more than a handful of people sitting next to the windshield in the first coach vehicle. This is an attractive seating location for children as it offers the best view. Thus, solutions are desired to avoid people becoming eyewitnesses to collisions and the resulting psychological consequences.

In addition, vehicle passengers like to enjoy scenery along the traveling path. Scenery enjoyment needs vary depending on the particular passenger or situation. Child passengers may have questions about a type of tree, elderly and visually-impaired passengers may have poor eyesight, and any passenger may have a view blocked by a person or another vehicle (e.g., when the target vehicle is in a middle lane and the passenger view is blocked by a vehicle in a side lane). Thus, solutions are desired to enhance passenger travel experience.

### DESCRIPTION OF THE DRAWINGS

FIGS. 1A-1C illustrate schematic diagrams of a system in accordance with aspects of the disclosure.

FIGS. 2A and 2B illustrate schematic diagrams of transparent window regions in accordance with aspects of the disclosure.

FIG. 3 illustrates a window optionally used as a screen in accordance with aspects of the disclosure.

FIGS. 4A-4B illustrate a virtual image creation system using a Generative Adversarial Network (GAN).

FIG. 5 illustrates a schematic diagram of a passenger enjoyment system overview in accordance with aspects of the disclosure.

FIG. 6 illustrates a schematic diagram of a vehicle passenger enjoyment system in accordance with aspects of the disclosure.

FIG. 7 illustrates a schematic diagram of a point of interest extraction system in accordance with aspects of the disclosure.

FIG. 8 illustrates a schematic diagram of a scenery caption generation system in accordance with aspects of the disclosure.

FIG. 9 illustrates a schematic diagram of a bookmark generation system in accordance with aspects of the disclosure.

FIG. 10 illustrates a schematic diagram of a content sharing system in accordance with aspects of the disclosure.

FIG. 11 illustrates a block diagram of an exemplary computing device in accordance with an aspects of the disclosure

### DESCRIPTION OF ASPECTS OF THE DISCLOSURE

### I. System 100

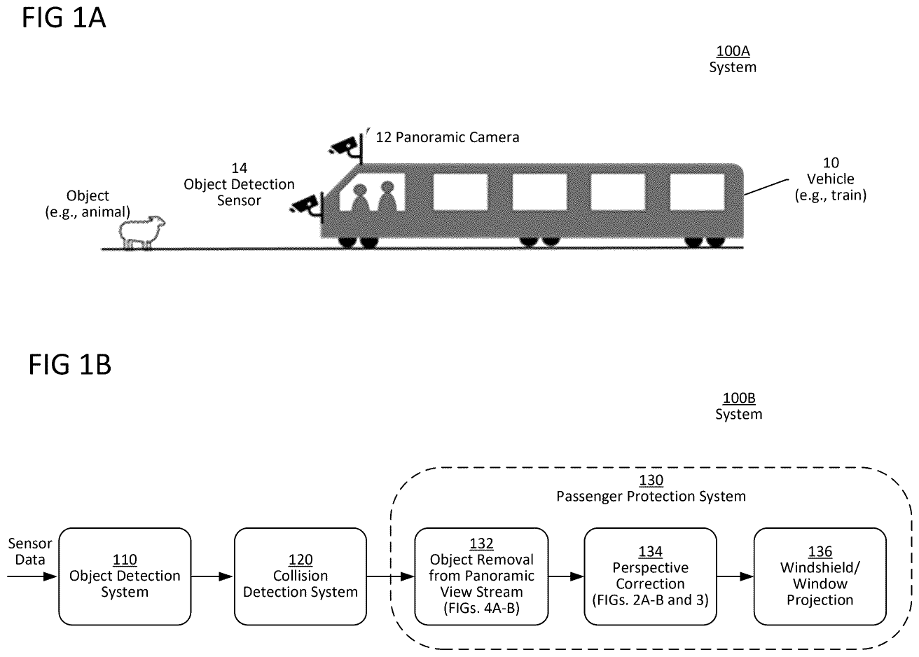

FIGS. 1A-1C illustrate schematic diagrams of a system 100 in accordance with aspects of the disclosure.

### A. Overview

The system 100 is configured to protect vehicle passengers from trauma due to a collision of the vehicle 10 with an object. The system 100 uses an object detection system 110 to perceive a surroundings of the vehicle (vehicle outside environment), coupled with a collision detection system 120 and a passenger protection system 130 to virtually eliminate a collision obstacle from the perceived environment.

The vehicle 10 may be, for example, a train. It is likely not possible to detect an obstacle (or other point of interest) early enough for a high-speed train to stop in time to avoid a collision. The train 10 is equipped with one or more sensors 12, 14 to detect the object in front of the train. If the collision system 120 detects a potential collision, the passenger protection system 130 may be activated. In normal operation, the train windshield may be a transparent window. But if the object detection system 110 and the collision detection system 120 determine that a collision is inevitable, the passenger protection system 130 is configured to manipulate the windshield to display an augmented reality. This augmented reality may be either an image of the current vehicle environment with the object removed, or a non-transparent screen, to prevent a front automated train passenger or a train driver from experiencing trauma due witnessing the collision.

The vehicle 10 is not limited to being a train, but may alternatively be an airplane to avoid panic about an engine failure, an automobile, or any another suitable vehicle. Also, the system 100 may additionally or alternatively be configured to project information of interest (e.g., city name, region-specific advertisement, etc.).

With this overview in mind, a more detailed explanation of the operation of the system 100 using a passenger train as an example, follows.

The system 100 comprises an object detection system 110, a collision detection system 120, a passenger protection system 130, and/or a passenger enjoyment system 600.

### B. Object Detection System 110

The object detection system 110 receives sensor data from onboard sensors 12, 14 (e.g., RGB camera, LiDAR, radar, etc.) that may be mounted in the front of the train 10 to detect potential obstacles on the track or objects that are about to cross the track. In addition, the object detection system 110 may receive sensor data from infrastructure sensors 16 (e.g., digital twin). Using infrastructure information can improve the responsiveness of the system 100 because a possible collision can be detected earlier with such off-board sensor data than with only on-board sensors.

### C. Collision Detection System 120

The collision detection system 120 comprises an object classification system 122, an object motion and prediction system 124, and a collision probability and severity estimation system 126.
1. Object Classification System 122

The object classification system 122 is configured to use any known classification approach to classify the detected object as a person, vehicle, animal, unknown object, etc.
2. Object Motion and Prediction System 124

The object motion and prediction system 124 is configured to estimate the object's motion, predict future movement, and output an object list with corresponding trajectories. The object's motion may be estimated using any known object tracker. The future movement may be predicted using any known solution.
3. Collision Probability and Severity Estimation System 126

The collision probability and severity estimation system 126 is configured to use the object list with corresponding trajectories from the object motion and prediction system 124 to estimate the collision probability. This system 126 intersects the trajectory of the object with the trajectory of the train 10, taking into consideration uncertainties. This system 126 may also consider any data from a map 18 or digital twin 16, if available. Useful map data could be, for example, information on track geometries and road crossings, with or without barriers. Data from the digital twin 16 may include data on the state of barriers, open or closed. The state of barriers may be used to improve the certainty of the trajectories. For example, if the train 10 is moving towards a closed barrier, the collision probability is relatively low. If, however, the object is a vehicle that is detected between closed barriers, the collision probability would be much higher.

Besides estimating how likely a collision is, the collision probability and severity estimation system 126 is configured to estimate the collision severity. For example, if the train 10 is about to collide with a heavy vehicle (e.g., classified as truck), the passenger protection system 130 might activate a warning. A collision with a truck will likely result in a noticeable physical impact. Thus the passenger protection system 130 may decide in this case to not make the window non-transparent or project a scenes on the window, but rather keep the window in a transparent state. However, when a non-noticeable impact is expected, such as that with an animal, the passenger protection system 130 may activate the envisioned virtual window feature.

The collision probability and severity estimation system 126 outputs a list of likely collisions (can be an empty list), with information on when and where the collision will happen (e.g., in 2 seconds, on right side of train), what type of object will be hit (e.g., animal), and how likely the collision will happen (e.g., 80%), and the expected severity (e.g., no injuries within train).

### D. Vehicle Passenger Protection System 130

The vehicle passenger protection system 130 is configured use the output from the collision probability and severity estimation system 126 to determine whether to warn train passengers that a severe collision is to be expected (e.g., high severity due to collision with truck), or alternatively, to provide the passengers with a virtual image. The warning option is straight forward and may be a simple audio message. The second option, to provide a virtual image, is now described in more detail.

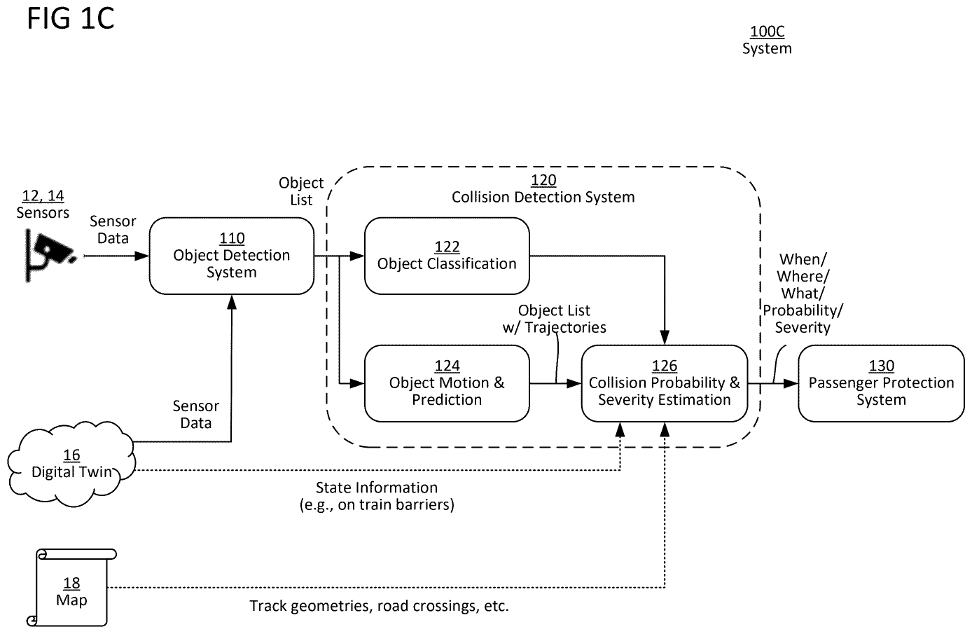

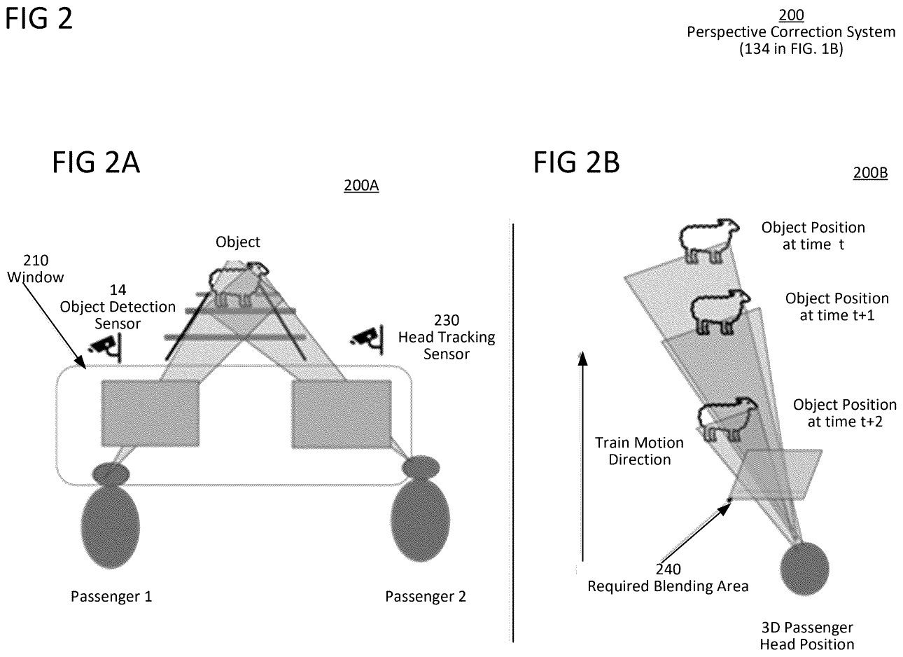

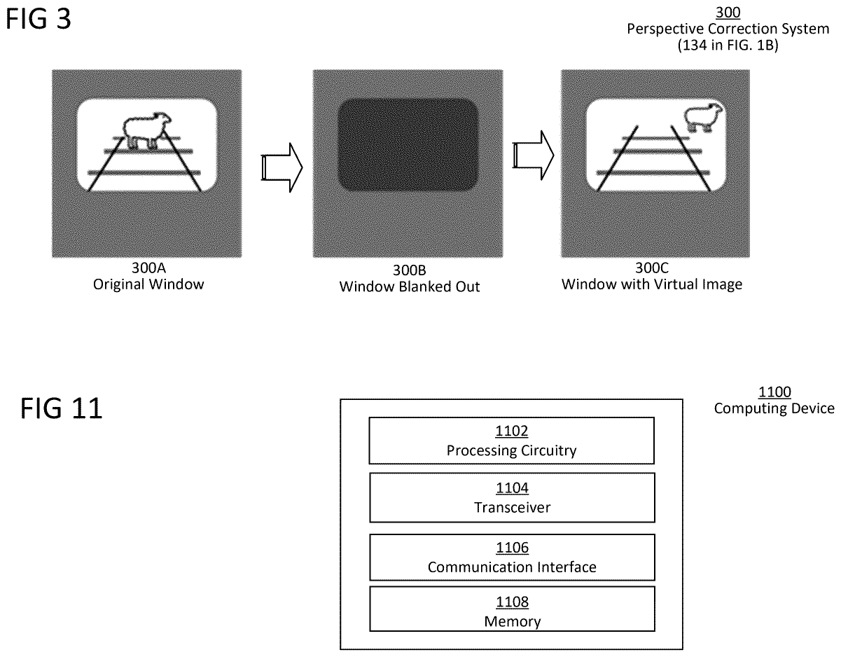

The vehicle passenger protection system 130 comprises an object removal from panoramic view system 132, a perspective correction system 134, and a windshield/window projection system 136. An example of the object removal from panoramic view system 132 is described below with respect to FIGS. 4A-4B. The perspective correction system 134 is described below with respect to FIGS. 2A, 2B, and 3. And the windshield/window projection system 136 may be any known display system.

FIGS. 2A-2B illustrate perspective correction system 200 (134 in FIG. 1B). Disclosed here are two possible options for manipulating the surroundings perceived by the passengers. The first option is to use windows 210 that can be made non-transparent by applying electronic signals. This is an inexpensive and fast solution that allows the system to make the entire window 210 non-transparent, or only a portion of the window 210. If only portions of the window are to be transparent, then a field-of-view (FOV) is estimated for each individual passenger using a head tracking sensor 230 and correlating the estimated FOV with positions of the object at different points in time (t, t+1, t+2 . . . ) until the collision. The intersection with the passengers' FOV and the object positions may be blurred out in a blending area 240. The system 100 thereby prevents the passengers from becoming an eye-witnesses to the collision. The switching time of the windows 210 may be in the order of a few milliseconds, so the passengers will probably not notice the image change from actual to virtual.

FIG. 3 illustrates a more advanced and less intrusive perspective correction system 300 (134 in FIG. 1B) with the window 300 also used as a display screen. The train 10 is equipped with panoramic cameras 14 to capture the entire scenery. The window 300A first shows the actual scenery. The window 300B may optional then be blanked out by applying an electric signal to act as a screen. And then additionally, or alternatively, the window 300C may show a virtual image with the object to be collided with either removed or placed in a non-collision location.

The stream of the camera(s) is better processed in real time for a better passenger experience, that is, at least 25 to 30 frames per second processed and generated, which is below the time the human eye would observe a non-smooth environment. However, even if fewer frames per second can be generated (e.g., just one static image), this is still better for the passengers than witnessing a collision.

FIGS. 4A-4B illustrate a virtual image creation system 400 using a Generative Adversarial Network (GAN) 430. The virtual image creation system 400 comprises a camera 410, a semantic segmentation system 420, a GAN 430, and a window display 440. The camera 410 is configured to obtain original image data, as shown in the left-hand image of FIG. 4A. The semantic segmentation system 420 is configured to process the image data to identify an obstacle in the original image, as shown in the middle image of FIG. 4A. This processing is disclosed as being achieved by semantic segmentation, but may alliteratively be achieved by another known process, such as yolo. The identified object region is provided to a GAN 430 together with the original image. Then the GAN 430 is configured to create a virtual image without the object, as shown in the right-hand image of FIG. 4A. After a correction of the perspective, to match the windows position, this image is then displayed on the window display 440. This is similar to an IMAX half dome in which perspective projections are used. Of course an observant person might feel a difference when this virtual world projection is activated, as all of a sudden, the human eyes need to focus on something at a shorter distance. However, this is acceptable sacrifice as compared with the passenger experiencing a collision with an animal or other human. Another option is to not only remove the object from image, but instead, use an AI algorithm to create a scenario in which the obstacle is moving away from the track. This creates a virtual solution, omitting the crash.

Further, the aspects disclosed herein may be used to activate windows to become non-transparent so as to prevent gawkers on highways. Gawkers unnecessarily slow down traffic to take pictures or videos of accidents or other bad situations. They also often hinder rescue and emergency people, thereby risking other lives. As a consequence, rescue and emergency people need to install blinds to avoid unnecessary hinderance.

The aspects of this disclosure may be deployed in vehicles 10 to address this issue in different ways. First, the police may remotely activate the feature using vehicle-to-everything (V2X) communication paths. Alternatively, the vehicle 10 itself may activate the feature by using map information 18, localization, and knowledge of rescue missions. The feature activation will be the side windows either becoming non-transparent, or, similar to the train embodiment, display a “normal” scene. As long as the driver is not required to pay attention (L3-vehicle or above), even the windshield could be handled in the same manner. In case a driver is operating the vehicle 10, the windshield should remain transparent, but more and more vehicles in the future will use camera-based mirrors, which will allow activation of the aspects of the disclosure for the side windows.

### E. Passenger Enjoyment System 600

1. Overview

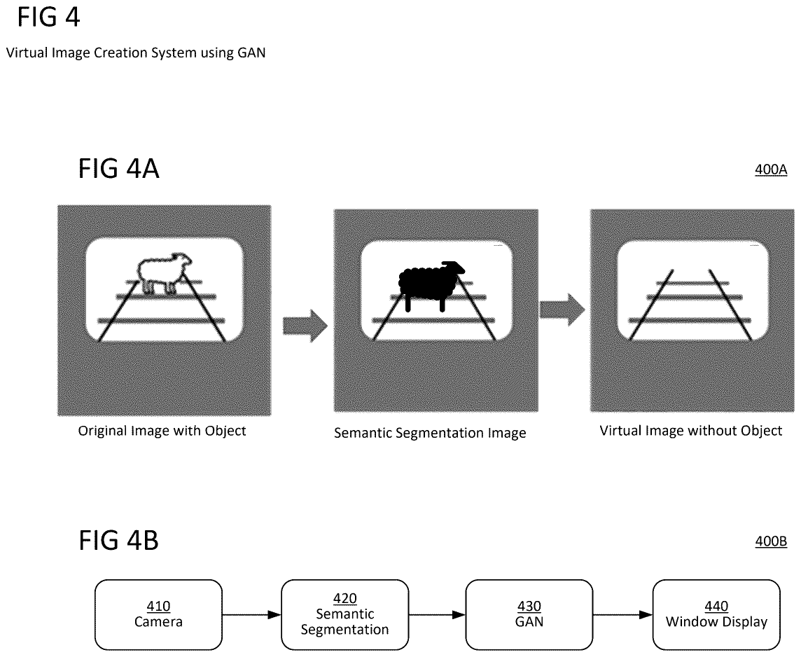

FIG. 5 illustrates a schematic diagram of a passenger enjoyment system overview 500 in accordance with aspects of the disclosure. The system may highlight, translate, and bookmark an image of scenery along a traveling route.

The vehicle surroundings are captured in images using cameras 12, an optionally additionally sounds using microphones 52. In the example shown, the vehicle 10 is driving in a middle lane with its view blocked by vehicles in adjacent lanes. The captured view is shown on one or more vehicle displays 54 (e.g., organic light-emitting diode (OLED) monitor, projector, AR/XR glasses, etc.). The passenger can view the scenery through both the display 54 and the vehicle window. A passenger interaction system 510 allows a vehicle passenger to obtain additional information about the scenery by pointing to a point of interest or clicking on the point of interest on the display 54. Then, the system modifies the image to caption or highlight the point of interest on the display 54, and may additionally translate the caption to another language. The translated language may be determined by both the scenery image, audio, and/or passenger profile. Additionally, a scenery bookmark system 530 may record and organize the images as personalized bookmarks, which may be referred to during a subsequent trip.
2. Vehicle Passenger Enjoyment System 600

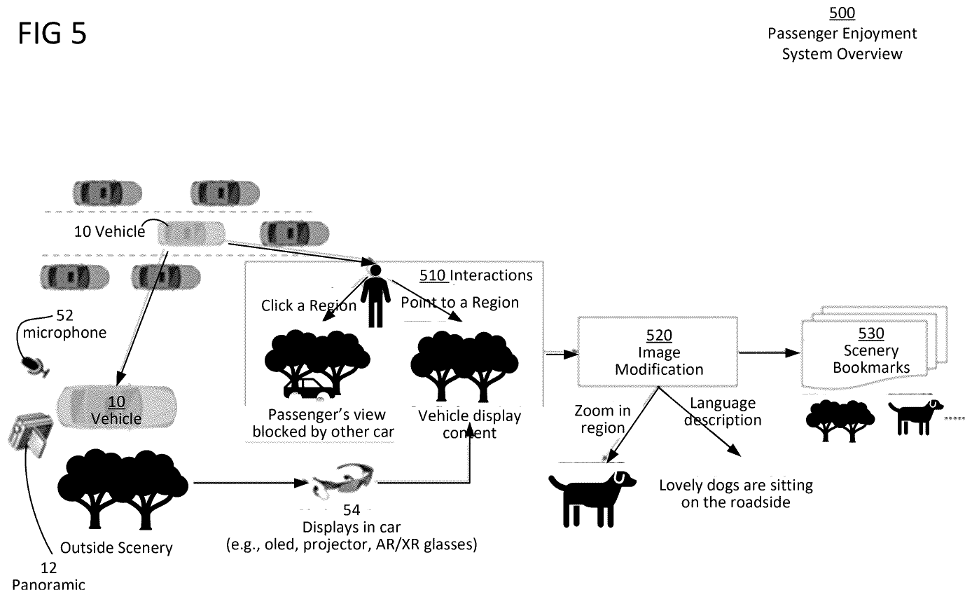

FIG. 6 illustrates a schematic diagram of a vehicle passenger enjoyment system 600 in accordance with aspects of the disclosure.

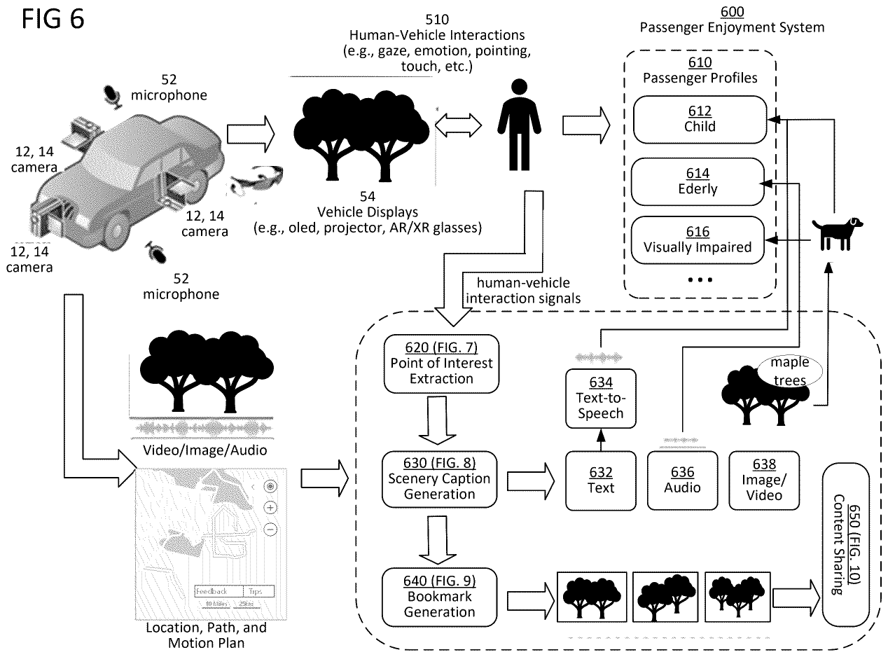

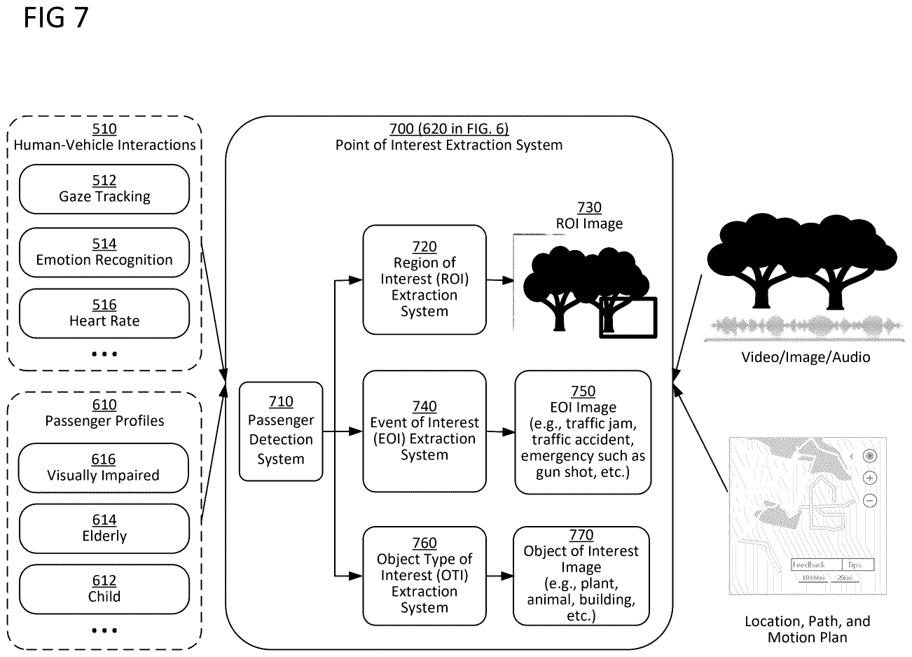

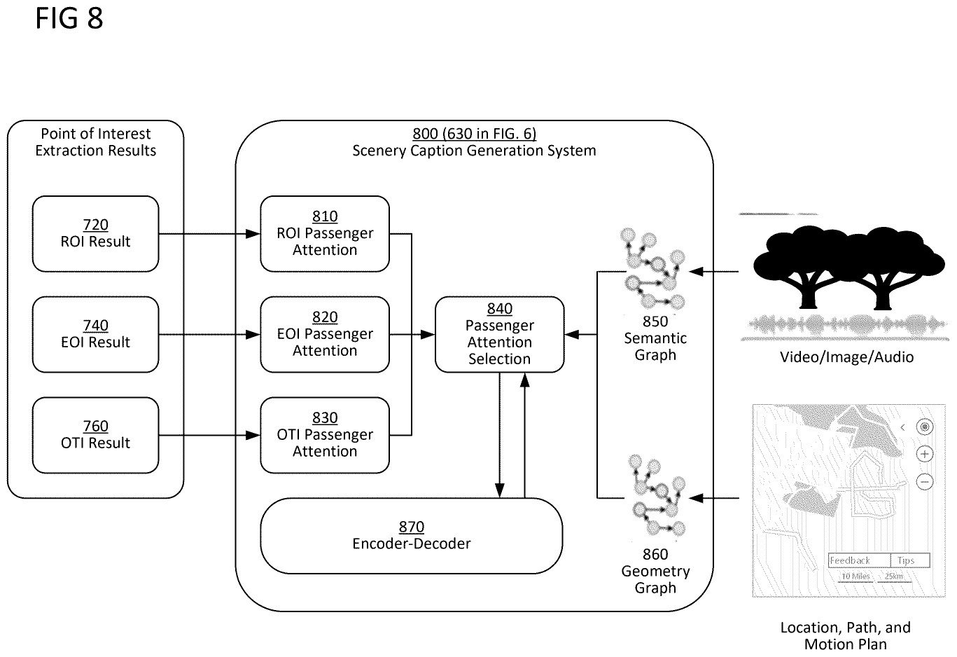

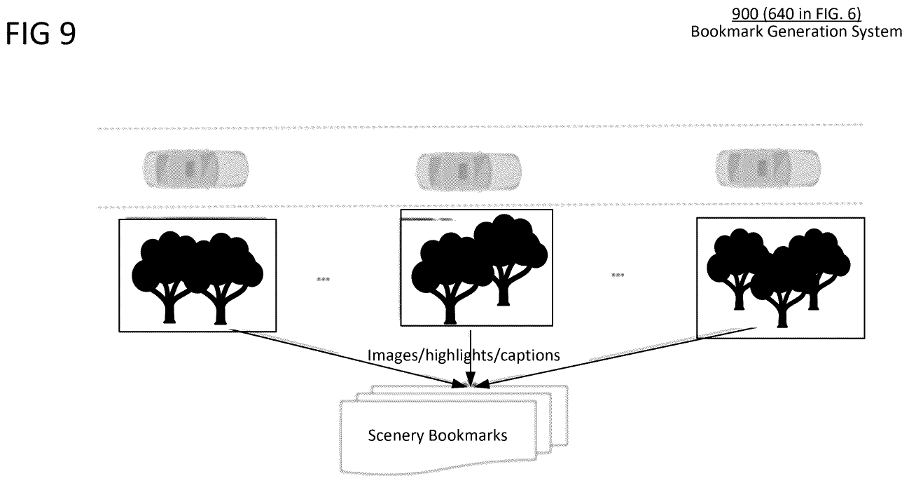

The passenger enjoyment system 600 allows vehicle passengers to have an improved traveling experience. The system 600 comprises passenger profiles 610, a point of extraction system 620 (more detail in FIG. 7), a scenery caption generation system 630 (more detail in FIG. 8), a bookmark generation system (more detail in FIG. 9), and a content sharing system 650 (more detail in FIG. 10).

By way of overview, cameras 12, 14 and microphones 52 capture a vehicle's surroundings, both visually and audibly. There are three possible inputs shown. A first input is the video/image/audio data that captures scenery information. The second input is the location, path, and motion plan that autonomous vehicles use for navigation. The third input is passenger interest based on the human-vehicle interactions 510 (e.g., gaze 510, emotion 514, heart rate 516, pointing direction, touching display location, etc.). Based on the inputs, the outputs are scenery captions (e.g., text 632, audio 636, and/or highlighted regions in images/videos 638), which are sent to vehicle passengers based on respective passenger profiles 610 (e.g., child 612, elderly 614, visually impaired 616, etc.). For example, for elderly 614 and visually impaired passengers 616, the passenger may receive a modified image that is zoomed in to a point of interest for a better view and/or audio explanation 636. The system 600 may also be configured to bookmark any recorded location, image, video, or audio.
3. Point of Interest (POI) Extraction System 620/700

FIG. 7 illustrates a schematic diagram of a point of interest extraction system 700 in accordance with aspects of the disclosure. A point of interest is, for example, natural scenery, historical building, etc.

The point of interest extraction system 700 comprises a passenger detection system 710, a region of interest (ROI) extraction system 720, an event of interest (EOI) extraction system 740, and an object type of interest (OTI) extraction system 760. The passenger detection system 710 is configured to detect by any known method (e.g., RFID tag, NFC, etc.) which passenger has entered the vehicle 10 so that the passenger's profile may be retrieved. A ROI is a sub-region of an image. An EOI is an event happening on the road, An OTI is a type of object. The ROI extraction system 720 is configured to output a modified image with a sub-region of the received image highlighted 730. The EOI extraction system 740 is configured to output a modified image of an event, such as a traffic jam, traffic accident, emergency such as gun shot, etc. The OTI extraction system 760 is configured to output a modified image of an object of interest, such as a plant, animal, building, etc.

The inputs to point of interest extraction system 700 include human-vehicle interactions 510, passenger profiles 610, video/image/audio signals, and navigation information. The human-vehicle interactions 510 may comprise eye gaze tracking 512, emotion recognition 512, heart rate 516, etc. The passenger profiles 610 are, for example, that a vehicle passenger prefers audio or video service, scenery type of interest, etc. The profile may be generated manually by the vehicle passenger or traffic work force, or may be generated automatically by a machine learning algorithm. The video/image/audio signals are of vehicle surroundings. The navigation information comprises location, map, and/or motion plans. Based on these inputs, the point of interest (POI) can be determined by any known process, such as a classifier (offline or online).
4. Scenery Caption Generation System 630/800

FIG. 8 illustrates a schematic diagram of a scenery caption generation system 800 in accordance with aspects of the disclosure.

The inputs to scenery caption generation system 800 comprise the point of interest extraction results 730, 750, 770, the scenery video/image/audio signals, and the navigation information (e.g., location, path, and motion plans). The outputs may comprise test, sentences, speech, and/or ROI of images describing the scenery generated using, for example, deep learning algorithms. A text output may be, for example, Example of generated caption: “There are few vehicles on the road. It starts raining and there are maple trees on the roadside. Dogs are sitting on the roadside.”

A passenger attention selection module 840 is configured to, based on a vehicle passenger's interests as indication in the corresponding profile, extract and select the vehicle passenger's attention. The scenery is represented by a semantic graph 850 and a geometry graph 860. The semantic graph 850 is configured to describe object and event types, such as there are maple trees, dogs, people, etc. The geometry graph 860 is configured to describe the location relationship between objects and events, for example, the sky is above the tree, building A is to the east of building B, etc.

An encoder-decoder 870 is configured to generate language description. There may be multiple decoders 870, such as Long Short Term Memory (LSTM), transformers, or the like. The encoder may employ a convolutional neural network (CNN), which extracts objects and features from an image or video frame. The decoder may employ a neural network that generates a natural sentence based on the available information.
5. Bookmark Generation System 640/900

FIG. 9 illustrates a schematic diagram of a bookmark generation system 900 in accordance with aspects of the disclosure.

The bookmark generation system 900 is configured to bookmark documented evidence of the trip. The system 900 is configured to record images, videos, and/or audio based on the vehicle passenger points of interest. The system 900 is also configured to record associated conversations in regard to the point of interests, for example, “I used to come to this beach during my high school time,” or “This is the church where my parents got married.” Similarly, recordings may be recalled from the bookmark database when the vehicle subsequently travels by related point of interests.
6. Content Sharing System 650/1000

FIG. 10 illustrates a schematic diagram of a content sharing system 1000 in accordance with aspects of the disclosure.

The content sharing system 1000 allows vehicle passengers of a same view to share content, either enabled by a client server, peer-to-peer, or other network architecture. The content sharing system 1000 allows a vehicle passenger to share a sub-set of content for their specific use cases. For example, vehicle passenger A might want to share a house image and related information to vehicle passenger B. The specific ROI/EOI/OT information 1010 attention of vehicle passenger A, which is the house, is displayed on the vehicle passenger B's view and allows vehicle passenger B to edit, add, delete, and any possible communication between them. The changes can be made either locally (e.g., at vehicle passenger B only) or globally (e.g., at both vehicle passengers A and B).

In addition to autonomous vehicles, the present invention may be applicable in other autonomous systems including autonomous robots, drones, unmanned aerial vehicles, etc. Further, “image” as defined herein may also encompass a portion of a video, which is a series of images.

### II. Computing Device

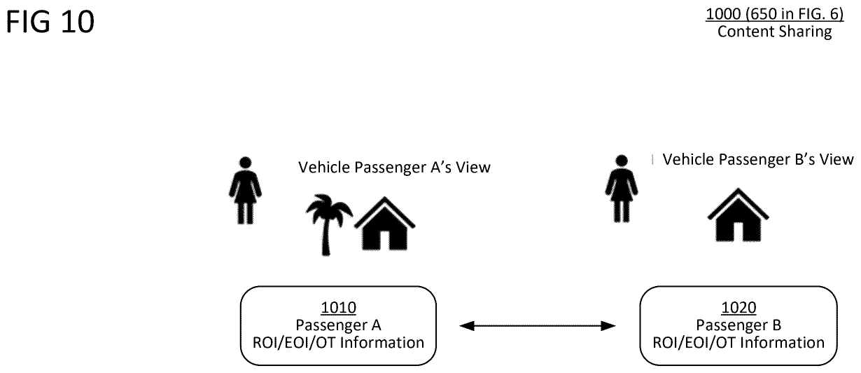

FIG. 11 illustrates a block diagram of an exemplary computing device in accordance with an aspects of the disclosure. In an aspect, the computing device 1100 as shown and described with respect to FIG. 11 may be identified with a central controller and be implemented as any suitable network infrastructure component, which may be implemented as an Edge network server, controller, computing device, etc. As further discussed below, the computing device 1100 may serve the environment in accordance with the various techniques as discussed herein. Thus, the computing device 1100 may perform the various functionality as described herein. To do so, the computing device 1100 may include processing circuitry 1102, a transceiver 1104, communication interface 1106, and a memory 1108. The components shown in FIG. 11 are provided for ease of explanation, and the computing device 1100 may implement additional, less, or alternative components as those shown in FIG. 11.

The processing circuitry 1102 may be configured as any suitable number and/or type of computer processors, which may function to control the computing device 1100. The processing circuitry 1102 may be identified with one or more processors (or suitable portions thereof) implemented by the computing device 1100. The processing circuitry 1102 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processing circuitry 1102 may be configured to carry out instructions to perform arithmetical, logical, and/or input/output (I/O) operations, and/or to control the operation of one or more components of computing device 1100 to perform various functions as described herein. The processing circuitry 1102 may include one or more microprocessor cores, memory registers, buffers, clocks, etc., and may generate electronic control signals associated with the components of the computing device 1100 to control and/or modify the operation of these components. The processing circuitry 1102 may communicate with and/or control functions associated with the transceiver 1104, the communication interface 1106, and/or the memory 1108. The processing circuitry 1102 may additionally perform various operations to control the communications, communications scheduling, and/or operation of other network infrastructure components that are communicatively coupled to the computing device 1100.

The transceiver 1104 may be implemented as any suitable number and/or type of components configured to transmit and/or receive data packets and/or wireless signals in accordance with any suitable number and/or type of communication protocols. The transceiver 1104 may include any suitable type of components to facilitate this functionality, including components associated with known transceiver, transmitter, and/or receiver operation, configurations, and implementations. Although depicted in FIG. 11 as a transceiver, the transceiver 1104 may include any suitable number of transmitters, receivers, or combinations of these that may be integrated into a single transceiver or as multiple transceivers or transceiver modules. The transceiver 1104 may include components typically identified with an RF front end and include, for example, antennas, ports, power amplifiers (PAS), RF filters, mixers, local oscillators (LOs), low noise amplifiers (LNAs), up-converters, down-converters, channel tuners, etc.

The communication interface 1106 may be configured as any suitable number and/or type of components configured to facilitate the transceiver 1104 receiving and/or transmitting data and/or signals in accordance with one or more communication protocols, as discussed herein. The communication interface 1106 may be implemented as any suitable number and/or type of components that function to interface with the transceiver 1106, such as analog-to-digital converters (ADCs), digital to analog converters, intermediate frequency (IF) amplifiers and/or filters, modulators, demodulators, baseband processors, etc. The communication interface 1106 may thus work in conjunction with the transceiver 1104 and form part of an overall communication circuitry implemented by the computing device 1100, which may be implemented via the computing device 1100 to transmit commands and/or control signals to the AMRs111 to execute any of the functions describe herein.

The memory 1108 is configured to store data and/or instructions such that, when the instructions are executed by the processing circuitry 1102, cause the computing device 1100 to perform various functions as described herein. The memory 1108 may be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 1108 may be non-removable, removable, or a combination of both. The memory 1108 may be implemented as a non-transitory computer readable medium storing one or more executable instructions such as, for example, logic, algorithms, code, etc.

As further discussed below, the instructions, logic, code, etc., stored in the memory 1108 are represented by the various modules/engines as shown in FIG. 11. Alternatively, if implemented via hardware, the modules/engines shown in FIG. 11 associated with the memory 1108 may include instructions and/or code to facilitate control and/or monitor the operation of such hardware components. In other words, the modules/engines as shown in FIG. 11 are provided for ease of explanation regarding the functional association between hardware and software components. Thus, the processing circuitry 1102 may execute the instructions stored in these respective modules/engines in conjunction with one or more hardware components to perform the various functions as discussed herein.

Various aspects herein may utilize one or more machine learning models to perform or control functions of the vehicle (or other functions described herein). The term “model” as, for example, used herein may be understood as any kind of algorithm, which provides output data from input data (e.g., any kind of algorithm generating or calculating output data from input data). A machine learning model may be executed by a computing system to progressively improve performance of a specific task. In some aspects, parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be adjusted during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, any of the machine learning models may utilize supervised learning, semi-supervised learning, unsupervised learning, or reinforcement learning techniques.

In supervised learning, the model may be built using a training set of data including both the inputs and the corresponding desired outputs (illustratively, each input may be associated with a desired or expected output for that input). Each training instance may include one or more inputs and a desired output. Training may include iterating through training instances and using an objective function to teach the model to predict the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various aspects described herein may utilize one or more classification models. In a classification model, the outputs may be restricted to a limited set of values (e.g., one or more classes). The classification model may output a class for an input set of one or more input values. An input set may include sensor data, such as image data, radar data, LIDAR data and the like. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (illustratively, starting from or using an input set of one or more values). References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

The techniques of this disclosure may also be described in the following examples.
Example 1. An apparatus, comprising: an interface for receiving image data in real-time of a surroundings of a vehicle; processing circuitry for: identifying a point of interest within the received image data; generating modified image data based on the received image data and the identified point of interest; and transmitting the modified image data to be displayed to a vehicle passenger.
Example 2. The apparatus of example 1, wherein: the point of interest is an object; and the processing circuitry is further for: detecting whether the vehicle will probably collide with the object; and if it is detected that the vehicle will probably collide with the object, generating the modified image data to obscure a collision of the vehicle with the object from the vehicle passenger.
Example 3. The apparatus of any of examples 1-2, wherein the processing circuitry, in detecting whether the vehicle will probably collide with the object, is further for: classifying a type of the object; predicting a motion of the object; estimating, based on the type and/or predicted motion of the object, a collision probability and/or collision severity; and generating the modified image data if the estimated collision probability and/or collision severity is greater than a predetermined threshold.
Example 4. The apparatus of any of examples 1-3, wherein the processing circuitry is further for: estimating the collision probability and/or collision severity based on map information and/or surroundings state information.
Example 5. The apparatus of any of examples 1-4, wherein the processing circuitry, in generating the modified image data to obscure the collision from the vehicle passenger, is further for: removing the object from the received image data; moving the object in the received image data to a different location within the modified image data; and/or outputting a signal to cause at least a portion of a window of the vehicle to be non-transparent.
Example 6. The apparatus of any of examples 1-5, wherein: the point of interest is an object; and the processing circuitry is further for: determining whether to generate modified image data based on a type of the object, a predicted motion of the object, an estimated probability of a collision between the vehicle and the object, and/or estimated severity of a collision between the vehicle and the object.
Example 7. The apparatus of any of examples 1-6, wherein the processing circuitry, in generating the modified image data to obscure the collision from the vehicle passenger, is further for: estimating, based on head-tracking image data received from a passenger head-tracking sensor, a field-of-view (FOV) of the passenger; correlating the FOV with positions of the object at respective points in time; and generating modified image data to modify the received image data within an intersection of the FOVs and correlated object positions.
Example 8. The apparatus of any of examples 1-7, wherein the modified image data or the received image data is displayed to the vehicle passenger in a window of the vehicle.
Example 9. The apparatus of any of examples 1-8, wherein when the received image data is not modified, the window of the vehicle is transparent.
Example 10. The apparatus of any of examples 1-9, wherein when the received image data is modified, the window of the vehicle is non-transparent.
Example 11. The apparatus of any of examples 1-10, wherein the processing circuitry is further for: identifying the point of interest based on a vehicle passenger profile, a vehicle passenger action, vehicle passenger speech, and/or a vehicle passenger emotion.
Example 12. The apparatus of any of examples 1-11, wherein the processing circuitry is further for: generating information about the point of interest, based on a vehicle passenger profile or a vehicle passenger action.
Example 13. The apparatus of any of examples 1-12, wherein the generated modified image data comprises a visual highlight of the point of interest.
Example 14. The apparatus of any of examples 1-13, wherein the generated modified image data comprises textual information related the point of interest.
Example 15. The apparatus of any of examples 1-14, wherein the processing circuitry is further for: translating the generated information into audio information.
Example 16. The apparatus of any of examples 1-15, wherein the processing circuitry is further for: generating a bookmark of the point of interest.
Example 17. The apparatus of any of examples 1-16, wherein the point of interest is a region of interest (ROI), an event of interest (EOI), or an object type of interest (OTI).
Example 18. The apparatus of any of examples 1-17, wherein the processing circuitry is further for: sharing the modified image data to be displayed to a person other than the vehicle passenger.
Example 19. The apparatus of any of examples 1-18, wherein the processing circuitry is further for: generating caption information about the point of interest, wherein the modified image data comprises the generated caption information.
Example 20. The apparatus of any of examples 1-19, wherein the processing circuitry is further for: identifying a profile related to the vehicle passenger.
Example 21. An autonomous system, comprising: the apparatus of any of examples 1-20.
Example 22. The autonomous system of any of examples 1-21, further comprising: a display for displaying the modified image data.
Example 23. The autonomous system of any of examples 1-22, wherein the display is comprised within a window of the vehicle.
Example 24. A component of a system, comprising: processing circuitry; and a non-transitory computer-readable storage medium including instructions that, when executed by the processing circuitry, cause the processing circuitry to: identify a point of interest within image data received in real-time of a surroundings of a vehicle; generate modified image data based on the received image data and the identified point of interest; and transmit the modified image data to be displayed to a vehicle passenger.
Example 25. The component of example 24, wherein the point of interest is an object, and the instructions further to cause processing circuitry to: detect whether the vehicle will probably collide with the object; and if it is detected that the vehicle will probably collide with the object, generate the modified image data to obscure a collision of the vehicle with the object from the vehicle passenger.
Example 26. An apparatus, comprising: an interface configured to receive image data in real-time of a surroundings of a vehicle; processing circuitry configured to: identify a point of interest within the received image data; generate modified image data based on the received image data and the identified point of interest; and transmit the modified image data to be displayed to a vehicle passenger.
Example 27. The apparatus of example 26, wherein: the point of interest is an object; and the processing circuitry is further configured to: detect whether the vehicle will probably collide with the object; and if it is detected that the vehicle will probably collide with the object, generate the modified image data to obscure a collision of the vehicle with the object from the vehicle passenger.
Example 28. The apparatus of example 27, wherein the processing circuitry, in detecting whether the vehicle will probably collide with the object, is further configured to: classify a type of the object; predict a motion of the object; estimate, based on the type and/or predicted motion of the object, a collision probability and/or collision severity; and generate the modified image data if the estimated collision probability and/or collision severity is greater than a predetermined threshold.
Example 29. The apparatus of example 28, wherein the processing circuitry is further configured to: estimate the collision probability and/or collision severity based on map information and/or surroundings state information.
Example 30. The apparatus of example 27, wherein the processing circuitry, in generating the modified image data to obscure the collision from the vehicle passenger, is further configured to: remove the object from the received image data; move the object in the received image data to a different location within the modified image data; and/or output a signal to cause at least a portion of a window of the vehicle to be non-transparent.
Example 31. The apparatus of example 26, wherein: the point of interest is an object; and the processing circuitry is further configured to: determine whether to generate modified image data based on a type of the object, a predicted motion of the object, an estimated probability of a collision between the vehicle and the object, and/or estimated severity of a collision between the vehicle and the object.
Example 32. The apparatus of example 27, wherein the processing circuitry, in generating the modified image data to obscure the collision from the vehicle passenger, is further configured to: estimate, based on head-tracking image data received from a passenger head-tracking sensor, a field-of-view (FOV) of the passenger; correlate the FOV with positions of the object at respective points in time; and generate modified image data to modify the received image data within an intersection of the FOVs and correlated object positions.
Example 33. The apparatus of example 26, wherein the modified image data or the received image data is displayed to the vehicle passenger in a window of the vehicle.
Example 34. The apparatus of example 33, wherein when the received image data is not modified, the window of the vehicle is transparent.
Example 35. The apparatus of example 33, wherein when the received image data is modified, the window of the vehicle is non-transparent.
Example 36. The apparatus of example 26, wherein the processing circuitry is further configured to: identify the point of interest based on a vehicle passenger profile, a vehicle passenger action, vehicle passenger speech, and/or a vehicle passenger emotion.
Example 37. The apparatus of example 26, wherein the processing circuitry is configured to: generate information about the point of interest, based on a vehicle passenger profile or a vehicle passenger action.
Example 38. The apparatus of example 37, wherein the generated modified image data comprises a visual highlight of the point of interest.
Example 39. The apparatus of example 37, wherein the generated modified image data comprises textual information related the point of interest.
Example 40. The apparatus of example 37, wherein the processing circuitry is further configured to: translate the generated information into audio information.
Example 41. The apparatus of example 36, wherein the processing circuitry is further configured to: generate a bookmark of the point of interest.
Example 42. The apparatus of example 36, wherein the point of interest is a region of interest (ROI), an event of interest (EOI), or an object type of interest (OTI).
Example 43. The apparatus of example 36, wherein the processing circuitry is further configured to: share the modified image data to be displayed to a person other than the vehicle passenger.
Example 44. The apparatus of example 26, wherein the processing circuitry is further configured to: generate caption information about the point of interest, wherein the modified image data comprises the generated caption information.
Example 45. The apparatus of example 36, wherein the processing circuitry is further configured to: identify a profile related to the vehicle passenger.
Example 46. An autonomous system, comprising: the apparatus of example 26.
Example 47. The autonomous system of example 46, further comprising: a display configured to display the modified image data.
Example 48. The autonomous system of example 47, wherein the display is comprised within a window of the vehicle.
Example 49. A component of a system, comprising: processing circuitry; and a non-transitory computer-readable storage medium including instructions that, when executed by the processing circuitry, cause the processing circuitry to: identify a point of interest within image data received in real-time of a surroundings of a vehicle; generate modified image data based on the received image data and the identified point of interest; and transmit the modified image data to be displayed to a vehicle passenger.
Example 50. The component of example 49, wherein the point of interest is an object, and the instructions further to cause processing circuitry to: detect whether the vehicle will probably collide with the object; and if it is detected that the vehicle will probably collide with the object, generate the modified image data to obscure a collision of the vehicle with the object from the vehicle passenger.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1-25. (canceled)

26. An apparatus, comprising:
an interface configured to receive image data in real-time of a surroundings of a vehicle;
processing circuitry configured to:
identify a point of interest within the received image data;
generate modified image data based on the received image data and the identified point of interest; and
transmit the modified image data to be displayed to a vehicle passenger.

27. The apparatus of claim 26, wherein:
the point of interest is an object; and
the processing circuitry is further configured to:
detect whether the vehicle will probably collide with the object; and
if it is detected that the vehicle will probably collide with the object, generate the modified image data to obscure a collision of the vehicle with the object from the vehicle passenger.

28. The apparatus of claim 27, wherein the processing circuitry, in detecting whether the vehicle will probably collide with the object, is further configured to:
classify a type of the object;
predict a motion of the object;
estimate, based on the type and/or predicted motion of the object, a collision probability and/or collision severity; and
generate the modified image data if the estimated collision probability and/or collision severity is greater than a predetermined threshold.

29. The apparatus of claim 28, wherein the processing circuitry is further configured to:
estimate the collision probability and/or collision severity based on map information and/or surroundings state information.

30. The apparatus of claim 27, wherein the processing circuitry, in generating the modified image data to obscure the collision from the vehicle passenger, is further configured to:
remove the object from the received image data;
move the object in the received image data to a different location within the modified image data; and/or
output a signal to cause at least a portion of a window of the vehicle to be non-transparent.

31. The apparatus of claim 26, wherein:
the point of interest is an object; and
the processing circuitry is further configured to:
determine whether to generate modified image data based on a type of the object, a predicted motion of the object, an estimated probability of a collision between the vehicle and the object, and/or estimated severity of a collision between the vehicle and the object.

32. The apparatus of claim 27, wherein the processing circuitry, in generating the modified image data to obscure the collision from the vehicle passenger, is further configured to:
estimate, based on head-tracking image data received from a passenger head-tracking sensor, a field-of-view (FOV) of the passenger;
correlate the FOV with positions of the object at respective points in time; and
generate modified image data to modify the received image data within an intersection of the FOVs and correlated object positions.

33. The apparatus of claim 26, wherein the modified image data or the received image data is displayed to the vehicle passenger in a window of the vehicle.

34. The apparatus of claim 33, wherein when the received image data is not modified, the window of the vehicle is transparent.

35. The apparatus of claim 33, wherein when the received image data is modified, the window of the vehicle is non-transparent.

36. The apparatus of claim 26, wherein the processing circuitry is further configured to:
identify the point of interest based on a vehicle passenger profile, a vehicle passenger action, vehicle passenger speech, and/or a vehicle passenger emotion.

37. The apparatus of claim 26, wherein the processing circuitry is configured to:
generate information about the point of interest, based on a vehicle passenger profile or a vehicle passenger action.

38. The apparatus of claim 37, wherein the generated modified image data comprises a visual highlight of the point of interest.

39. The apparatus of claim 37, wherein the generated modified image data comprises textual information related the point of interest.

40. The apparatus of claim 37, wherein the processing circuitry is further configured to:
translate the generated information into audio information.

41. The apparatus of claim 36, wherein the processing circuitry is further configured to:
generate a bookmark of the point of interest.

42. The apparatus of claim 36, wherein the point of interest is a region of interest (ROI), an event of interest (EOI), or an object type of interest (OTI).

43. The apparatus of claim 36, wherein the processing circuitry is further configured to:
share the modified image data to be displayed to a person other than the vehicle passenger.

44. The apparatus of claim 26, wherein the processing circuitry is further configured to:
generate caption information about the point of interest, wherein the modified image data comprises the generated caption information.

45. The apparatus of claim 36, wherein the processing circuitry is further configured to:
identify a profile related to the vehicle passenger.
